(19) United States
(12) Patent Application Publication
(10) Pub. No.: US 2008/0313130 A1
(43) Pub. Date: Dec. 18, 2008

(54) Method and System for Retrieving, Selecting, and Presenting Compelling Stories form Online Sources

(75) Inventors: Kristian J. Hammond, Chicago, IL (US); Sara H. Owsley, Evanston, IL (US); Sanjay C. Sood, Evanston, IL (US)

Correspondence Address: FERNANDEZ & ASSOCIATES LLP, 1047 EL CAMINO REAL, SUITE 201, MENLO PARK, CA, 94025, US

(73) Assignee: Northwestern University, Evanston, IL (US)

(21) Appl. No.: 11/763,324

(22) Filed: Jun. 14, 2007

(51) Int. Cl. G06F 17/30

(52) U.S. Cl. 707/2

(57) ABSTRACT

The invention provides a method and system for automatically retrieving, selecting, and presenting compelling stories from online sources. The system mines the online sources and collects texts that are likely to contain compelling stories. The system then extracts candidate stories from them and transforms these candidate stories to make them appropriate for presentation. The candidate stories are then passed through a set of filters to focus the system on stories with a heightened emotional state. Techniques are used to ensure retrieval of appropriate and meaningful content for the performance of the stories. The modified and filtered stories are then prepared for presentation, including marked up with speech and animation cues, gender classification, and dramatic Adaptive Retrieval Charts (or ARCs). These ARCs allow for various performance types from an ongoing performance of multiple actors in a physical installation to single actor performance of a single story for an online system.

### BACKGROUND

1. Field

The present invention relates to computer-based story telling, and more particularly to the automatic, animated and spoken presentation of stories from blogs and other online sources by computer.

2. Related Art

The Internet is a living, breathing reflection of our society, who people are, what they think, and how they feel. The pages that make up the Web form the book of our contemporary life and culture. They are the ongoing and changing buzz of our world. The latest embodiment of this cultural reflection is found in online sources such as blogs. Blogs are increasingly widespread and incredibly dynamic, with hundreds updated each minute. The existence of millions of blogs on the web has resulted in more than the mere presence of millions of online journals: they generate a collective buzz around the events of the world.

Story telling and online communication have been externalized in a small number of multimedia delivery systems. For example, one system exposes content from thousands of chat rooms through an audio and visual display. However, these multimedia deliveries typically lack character development, content quality, and other aesthetic elements that characterize genuine stories. A method and system for retrieving, selecting, and presenting compelling stories from online sources are thus absent from the existing art.

### SUMMARY

The invention provides a method and system for automatically retrieving, selecting, and presenting compelling stories from online sources. The system mines the online sources and collects texts that are likely to contain compelling stories. After retrieving these texts, the system extracts candidate stories from them. The system then modifies the candidate stories to make them appropriate for spoken presentation by animated characters. The candidate stories are then passed through a set of filters, aimed at focusing the system on stories with a heightened emotional state. Other techniques, including syntax filtering and colloquial filtering, are also used to ensure retrieval of appropriate and meaningful story content for the performance. The modified and filtered stories are then marked up with speech and animation cues in preparation for performance by an animated character. Gender classification is used to ensure that gender-specific stories are performed by virtual actors of the appropriate gender. Dramatic Adaptive Retrieval Charts (or ARCs) are used to provide a higher level control of the performance, similar to that of a director. These ARCs allow for various performance types from the most basic—an individual virtual actor telling an individual story, for example as part of an online system—to more complex—for example, an ongoing performance of multiple virtual actors in a physical installation.

### BRIEF DESCRIPTION OF DRAWINGS

FIG. 1A illustrates an example installation of the system.

FIG. 1B illustrates the central screen of the installation of the system.

FIG. 2 illustrates an exemplary embodiment of a system for retrieving, selecting, and presenting compelling stores from online sources.

FIG. 3 illustrates the integration of a model for the retrieval, filtering, and modification of stories into an exemplary embodiment of the system.

FIG. 4 illustrates a sample dramatic ARC to drive a performance.

### DETAILED DESCRIPTION

The invention provides a method and system for automatically retrieving, selecting, and presenting compelling stories from blogs and other online sources. The system mines the online sources and finds stories that are selected for their emotional impact. Such stories can be touching, funny, surprising, comforting, eye-opening, etc. They expose people's fears, dreams, experiences, and opinions. Instead of simply presenting the stories as plain text, the system embodies the author with an animated avatar and generated voice, enabling a stronger connection with the viewer.

Although the exemplary embodiment is described herein in the context of blogs, the described methods can be applied to the retrieval, selection, and presentation of compelling stories from other online sources or repositories without departing from the spirit and scope of the invention.

To provide a sense of the kinds of stories retrieved and selected for presentation, the table below (Table 1) shows three stories read in a performance.

TABLE 1
My husband and i got into a fight on saturday night; he was drinking and
neglectful, and i was feeling tired and pregnant and needy. it's easy to understand how
that combination could escalate, and it ended with hugs and sorries, but now i'm feeling
fragile. like i need more love than i'm getting, like i want to be hugged tight for a few
hours straight and right now, like i want a dozen roses for no reason, like a vulnerable
little kid without a saftey blankie. fragile and little and i'm not eating the crusts on my
sandwich because they're yucky. i want to pout and stomp until i get attention and
somebody buys me a toy to make it all better. maybe i'm resentful that he hasn't gone out
of his way to make it up to me, hasn't done little things to show me he really loves me,
and so the bad feeling hasn't been wiped away. i shouldn't feel that way. it's stupid; i
know he loves me and is devoted and etc. yet i just want a little something extra to make
up for what i lost through our fighting. i just want a little extra love in my cup, since
some of it drained.
I have a confession. It's getting harder and harder to blindly love the people who
made George W Bush president. It's getting harder and harder to imagine a day when my
heart won't ache for what has been lost and what we could have done to prevent it. It's
getting harder and harder to accept excuses for why people I respect and in some cases
dearly love are seriously and perhaps deliberately uninformed about what matters most to
them in the long run.
I had a dream last night where I was standing on the beach, completely alone,
probably around dusk, and I was holding a baby. I had it pulled close to my chest, and all
I could feel was this completely overwhelming, consuming love for this child that I was
holding, but I didn't seem to have any kind of intellectual attachment to it. I have no idea
whose it was, and even in the dream, I don't think it was mine, but I wanted more than
anything to just stand and hold this baby.

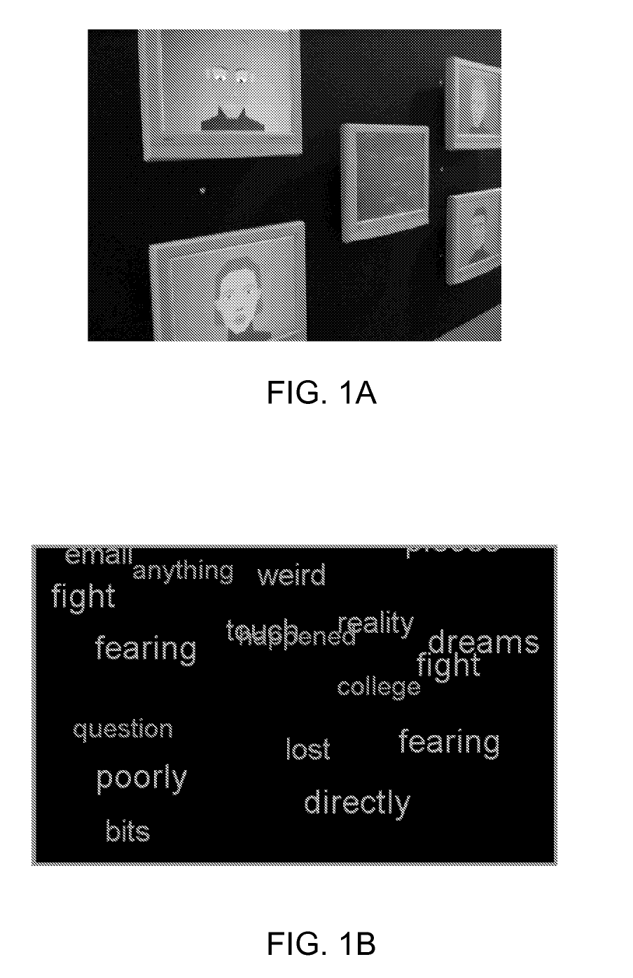

FIGS. 1A and 1B illustrate an example installation of the system. The installation includes five flat panel monitors in the shape of an ‘x’. The four outer monitors display virtual actors. The actors contribute to the performance by reading the stories retrieved and selected from blogs aloud, in turn. The actors are attentive to each other by turning to face the actor currently speaking. FIG. 1B illustrates the central screen of the installation, which displays the emotionally evocative words extracted from the story currently being performed.

Other embodiments of this system use the same core infrastructure in order to gather and present stories. One such version exists as a destination entertainment web site, rather than a physical installation. On this site, users can view stories through a single avatar, as opposed to a group of avatars. A diverse set of actors fill the site with video presentations, telling the compelling stories found by the system. The videos are navigated via topical search or browsed through a set of hierarchical categories. The site allows users to comment on videos, rate them, and recommend them to friends.

The stories retrieved and selected by the system may be delivered by other multimedia means without departing from the spirit and scope of the invention. Or they may be presented in any other form, for example, simply in textual form. Or they may be used for purposes other than presentation to users, for example, analyzed and evaluated individually or in the aggregate.

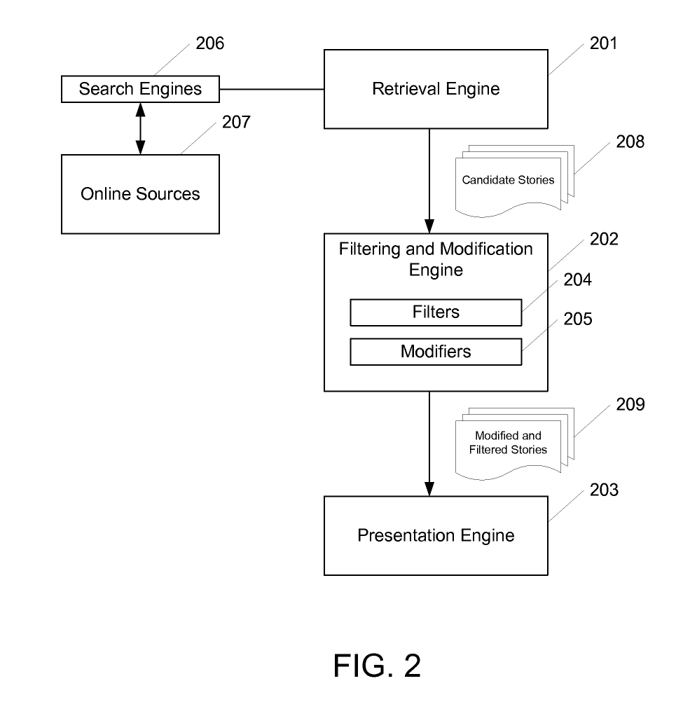

FIG. 2 illustrates an exemplary embodiment of a system for retrieving, selecting, and presenting compelling stories from online sources. The system includes a retrieval engine 201, a filtering and modification engine 202, and a presentation engine 203. The retrieval engine 201 generates queries likely to result in retrieval of stories of interest, retrieves posts from online sources 207 using search engines 206, and extracts candidate stories 208 from the search results. The candidate stories 208 are then passed to the filtering and modification engine 202. The filtering and modification engine 202 passes the candidate stories 208 through a set of filters 204 to focus on stories with a heightened emotional state as well as meeting other conditions. The modifiers 205 modify the stories to make them appropriate for presentation. The modified and filtered stories 209 are then passed to the presentation engine 203, which prepares the stories for spoken performance by an animated character or avatar.

To find compelling stories in blog postings or other online documents, the system mines the blogosphere (the global corpus of blogs) and other online sources, collecting blogs or texts wherein the author describes a dramatic and compelling situation: a dream, a nightmare, a fight, an apology, a confession, etc. After retrieving these blogs, the system extracts candidate stories from the entries. It then transforms these candidate stories to make them appropriate for presentation, truncating them when necessary. The candidate stories are then passed through a set of filters, aimed at focusing the system on blogs with a heightened emotional state. Other techniques including syntax filtering and colloquial filtering are used to ensure retrieval of appropriate and meaningful content for performance.

After passing through these filters, the resulting story selections are emotion-laden and compelling. Next, the system must prepare these stories to be performed by an animated character. Several techniques are used to give the presentation of the stories a realistic feel and to make performances engaging to an audience. The story is marked up for speech and animation cues in a number of ways. The story is marked up at a sentence level by a mood classifier, providing cues to the avatar and generated voice as to the affective state of the story as it progresses. This markup also includes emphasis and timing cues to yield better cadence and prosody from computer-generated voices. Gender classification is used to ensure that gender-specific stories are performed by virtual actors of the appropriate gender. Dramatic Adaptive Retrieval Charts (or ARCs) are used to provide a higher level control of the performance, similar to that of a director. These ARCs allow for various performance types, from a basic performance of a single story by a single virtual actor, for example in an online system, to an ongoing performance of multiple actors in a physical installation.

Compelling Stories

The content of blogs is incredibly wide-ranging, but unfortunately often very dull. People blog about a wide range of topics, including their class schedule, what they are eating for lunch, how to install a wireless router, what they wore today, and a list of their 45 favorite ice cream flavors. While this is interesting to observe from a sociological point of view, it does not make for a compelling performance. Not only are the blogs on these topics boring, but the lengths of the blog posts varied widely from one sentence to pages upon pages, and most do not take the form of a story or narrative.

To find stories that will be compelling and engaging to an audience, the system employs a model for the aesthetic qualities of a compelling story. These qualities include but are not limited to:

1. on an interesting topic

2. emotionally charged

3. complete and of an appropriate length to hold the audience's attention

4. involving dramatic situations

5. familiar to an audience, so that they can relate to it

6. comprised of developed characters

Retrieval, Filtering and Modification Model

The system uses a model for the retrieval, filtering, and modification of stories that takes advantage of the vast size of the blogosphere and other online sources, aggressively filtering the retrieval of stories. The system does not necessarily strive for completeness, or what is termed “recall” in information retrieval. Rather, the goal is to ensure that retrieved texts are very likely to be interesting stories (analogous to what is termed “precision” in information retrieval). First, the system retrieves a large set of texts using existing web search engines. The retrieval process includes a query formation stage, retrieval of blogs or other documents from the existing search engines, result processing, and the extraction of candidate texts. Following this stage, candidate stories are extracted from the texts and modified and filtered based on many different metrics. The stories that pass through all these filters and modifications are known to be impactful and appropriate stories for presentation in a multimedia performance.

There are three functional categories for the system's filters and retrieval strategies. Story filters are those which narrow the blogosphere or other universe of documents down to those (blog) posts that include stories, including strategies that make use of punctuation, topics, phrasal story cues, and completeness to indicate a text that is likely to have a dramatic point. Content or impact filters are used to find interesting and appropriate stories—those with elevated emotion, and with familiar and relevant content that is free of profanity and other unwanted language use. Presentation filters are used to focus on content that will sound appropriate when spoken through a computer-generated voice, and presented by an animated avatar of the appropriate gender. Any of these filters are configurable to adjust to different deployments.

In addition to filters, there is also a set of modifiers that alter the text of the retrieved and filtered stories. Story modifiers alter the text so that the structure looks more like a story. Presentation modifiers change the text to make it sound more appropriate in spoken as opposed to written form.

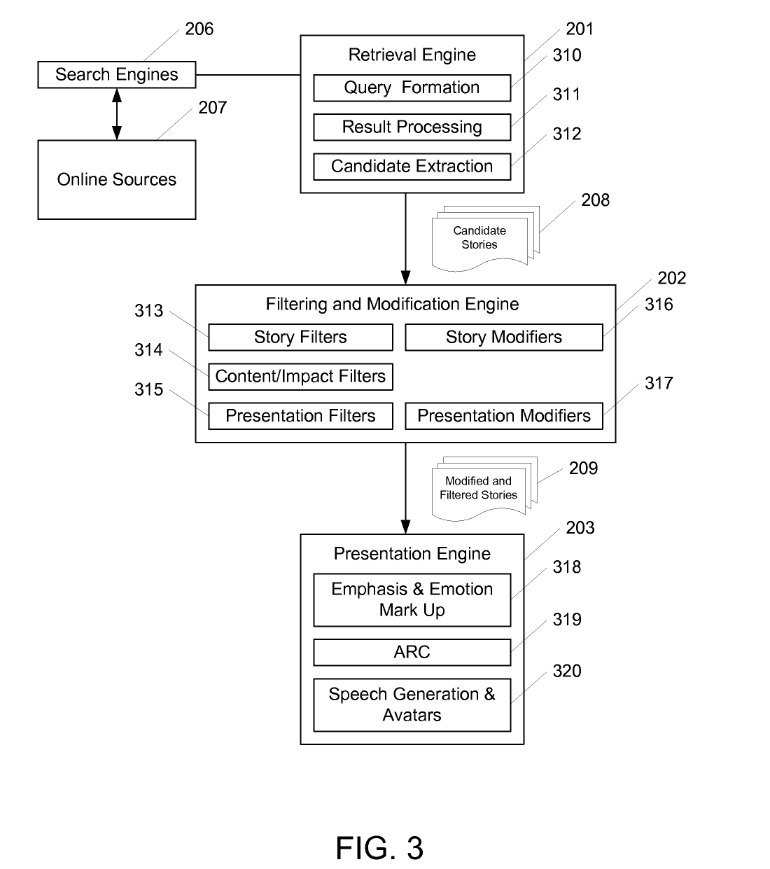

FIG. 3 illustrates the integration of this model in the exemplary embodiment of the system. The retriever 201 forms queries 310 to mine the blogosphere or other online sources, processes the results 311, and extracts candidate stories 208 from the candidate blog posts or other documents 312. The filtering and modification engine 202 filters the candidate stories 208 through the story filters 313, content/impact filters 314, and presentation filters 315. In addition, the story modifiers 316 and presentation modifiers 317 modify the candidate stories 208 for presentation. The presentation engine 203 plans the structure of the performance of the modified and filtered stories 209 for emphasis and emotion markup 318 and is driven by an ARC 319. The stories are then presented using speech generation and animated avatars 320.

The following sections further describe the integration of the above-mentioned retrieval strategies, filters, and modifiers in the overall system.

Retrieval Engine (201)

Query Formation (310)

There are multiple types of queries that are used in the exemplary system. One query strategy uses topics of interest topics found on the web, while a second query strategy uses a library of structural story cues to seek texts that take the form of a story. Queries of the first type are formed using a standard information retrieval technique (TFIDF) combined with phrasal indicators such as “I think” or “I feel” to target opinions and points of view on the target news story.

Topics of Interest

A compelling story is generally about a compelling topic, one that interests the audience. The system employs a variety of methods aimed at focusing on topics of interest to the audience. For example, one useful query strategy is to choose the currently most popular searches as topics. Some search engines provide a log of their most frequent queries or query topics. For example, Yahoo!™ provides the topics most frequently queried by their users in a set of categories. Their categories currently include: Overall, Actors, Movies, Music, Sports, TV, and Video Games. In the Actors category, the top three topics from Mar. 7, 2007 are “April Scott,” “Lindsay Lohan,” and “Jessica Alba.” In the Overall category, the top three topics from Mar. 7, 2007 are “Britney Spears,” “Antonella Barba,” and “Anna Nicole Smith.”

As another example, the system uses Wikipedia™ as a source of potentially interesting topics. This site maintains a list of “controversial topics” that are in “edit wars” on Wikipedia as contributors are unable to agree on the subject matter. This list includes topics such as “apartheid,” “overpopulation,” “ozone depletion,” and “censorship.” These topics, by their nature, are topics that people are passionate about. One Mar. 7, 2007, Wikipedia's “List of controversial issues” included such topics as “Bill O'Reilly,” “Abortion,” “Osama bin Laden,” “Stem Cell Research,” “Censorship,” “Polygamy,” and “MySpace.”

Using these types of sources for topics of interest, the selected topics are used to form queries and sent to a set of existing blog search engines. Using topics of interest as the source of topic keywords and blogs as the target, the system is able to discover what is being said about what people are most interested in today.

Structural Cues

The most compelling stories to watch or hear are those in which someone is laying his or her feelings on the table, exposing a dream or a nightmare that they had, making a confession or apology to a close friend, regretting an argument that they had with their mother or spouse, etc.

Codifying these qualities, another query strategy utilized by the system seeks out these types of stories based on structural story cues indicative of a story. These cues are designed to find instances in which a writer is starting to tell a story in the form of a dream, nightmare, fight, apology, confession, or any other emotionally fraught situation. Such cues include phrases such as “I had a dream last night,” “I must confess,” “I had a terrible fight,” “I feel awful,” “I'm so happy that,” and “I'm so sorry,” etc. The most straightforward structural story cue would be if the author wrote, “I have a story to tell you,” or even (for fairy tales), “Once upon a time.”

The exemplary embodiment of the system focuses on stories involving different types of emotion-laden situations (dreams, fights, confessions, etc.). These stories are more interesting as the blogger isn't merely talking about a popular product on the market, or ranting about a movie; they are relaying a personal experience from their life, which typically makes them emotionally charged. The experiences they describe are often frightening, funny, touching, or surprising. They describe situations which often have an element in common with all of our lives, allowing the audience to embed themselves in the narrative and truly connect with the writer.

In a well-known 19th century treatise, the French writer Georges Polti enumerated 36 situational categories into which all stories or dramas fall. These include such modern categories as vengeance, pursuit, abduction, murderous adultery, mistaken jealousy, and loss of loved ones. While the language Polti used to describe these situations now sounds somewhat dated, the concepts behind these situational categories bear a resemblance to the types of stories that the system determines might be interesting to hear.

Including structural story cues as described above in a search query not only results in more interesting story topics and content, but the stories also tend to have more character depth and development. As writers describe dramatic situations in their own lives, more aspects of their personality and of personal issues involving themselves and others around them are revealed.

Blog Retrieval and Result Processing (311)

The queries formed in the query formation step 310, such as “I had a dream last night,” are sent to a set of search engines 206. The system collects the top n results (where n is a configurable parameter). Each result contains a title, summary, and URL of a blog or other document related to the given query. The system filters duplicate results and non-blog results (i.e., user profile pages). Next, the HTML content for each blog result is retrieved.

Candidate Extraction (312)

The content for each such result may contain multiple posts which may or may not be relevant to the query. To identify the relevant posts or portions within the blog result or other document, “text” tags in the HTML of the blog entry are removed (i.e., formatting tags used to alter the look of text such as the italics tags, the bold tag, the underline tag, and the anchor tag). If the retrieved documents were in some other format, different conventions would be taken into account in removing formatting commands or indicators. After removing these tags, the system finds occurrences of the given query terms and structural story cues on the page. For each occurrence, it searches for the last previous occurrence of, and the next occurrence of, a natural breaking point. The natural breaking point might, for example, be paragraph boundaries. The section between these two points is taken as a candidate story. The tags before and after a piece of text will be tags that divide paragraphs, so the algorithm will accomplish the goal of finding the relevant paragraphs.

Following the candidate extraction step 312, what remains is a set of candidate stories 208, ready to be sent through the filtering and modification engine 202.

Filtering and Modification Engine (202)

The filtering and modification engine consists of sets of filters or evaluation methods aimed at assessing various qualities of candidate stories, as well as modification rules aimed at transforming the text to improve their qualities along a number of dimensions. These filters and modifiers can be configured in a variety of different sequences and control structures in order, e.g., to meet efficiency or yield requirements for a given implementation. The filters, in particular, may be used with thresholds independently to select among candidate stories, or to rank candidate stories, or may be combined in weighted sums (linear combinations) or other combination schemes for comparison with a threshold or for ranking. If used individually or in combination for ranking purposes, the resulting ranking may then be used to select the n highest-ranked candidate stories, where n is a configurable parameter of the system.

The filtering and modification methods described here may also be used in a variety of other information retrieval settings, to find compelling or interesting content in genres other than stories, for example, opinions, or news articles.

Story Filters (313)

Story filters are those which narrow the blogosphere or other universe of documents down to those (blog) posts that include stories, including strategies that make use of punctuation, relevance to topics, inclusion of phrasal story cues, and completeness.

Relevance to Topics of Interest and Inclusion of Structural Story Cues

The story filters 313 evaluate the relevance of candidate stories to the topics of interest and/or the structural story cue used in their retrieval. In the case of a topic of interest query, the candidate stories are phrasally analyzed, eliminating candidates that are not sufficiently on point. For example, candidates that do not include at least one of the two-word phrases (non-stopwords) from the topic may be eliminated. For instance, given the topic ‘Star Wars: Revenge of the Sith,’ entries that contain the phrase ‘star wars’ are acceptable, but not entries that merely have the word ‘star’ or ‘wars.’ In the case where a candidate has been retrieved based on a structural story cue query, the candidate story is analyzed to ensure that the story cue is present, and that it occurs in the first sentence of the story. In some cases, the text may be modified to make this last condition true. This ensures that the structural cue is used as intended, to start the story.

Complete Passages

Finding stories that are complete passages involves finding complete thoughts or stories of a length that can keep the audience engaged. For the most part, blog authors (and for that matter most authors) format their entries in a way such that each paragraph contains one distinct thought. Under this assumption, the paragraph where the structural story cue and/or topic is mentioned with the greatest frequency often suffices as a complete story. Given the method described above to extract candidate stories from blogs or other documents, these candidate stories will likely take the form of a complete paragraph. If this paragraph is of an ideal length (between a minimum and maximum threshold), then it is proposed as a candidate story. Again, given the large volume of blogs or other relevant contributions on the web, letting many blogs fall through the cracks because they are too long or too short can be acceptable for the system's purposes.

Filtering Retrieval by Syntax

The system as described so far often finds text that may not be a narrative, such as lists or surveys. For example, one blogger posted an exhaustive list of lip balm flavors. Others posted answers to a survey about themselves (their favorite vacation spot, favorite color, favorite band and actor, etc.). These are clearly not good candidates for stories to be presented in a performance.

To solve this problem, the system filters the retrieved stories by syntax. In the exemplary embodiment, stories that meet any of the following syntactical indicators are removed as they often signify a list:

1. too many newline characters (for example, more than six in an entry of four hundred characters)

2. too many commas (for example, more than three in a sentence or more than one in 15 characters)

3. too many numbers (for example, more than one number—no longer than 4 continuous digits—in a sentence)

Other parameters may be used instead of or in addition to those listed.

While the recall of stories that pass through this filter-based on syntax can be lower than other methods, the system is optimized for precision so that the remaining stories do not contain lists or surveys. Given the large volume of blogs and other documents on the web updated every minute, letting some potentially good blogs or other candidates fall through the cracks is generally acceptable for the system's purposes.

Story Modifiers (316)

Story modifiers are modification strategies aimed at transforming the candidate story into a more story-like structure. The main strategy in this category involves the structural story cues described in the previous section. While these cues are initially used by a method to retrieve and filter stories, they are also used to truncate the blog post into the section that structurally is most like a story. Often blog posts or other documents are retrieved that include the story cue, but it occurs in the middle of a paragraph. Since the stories are initially divided by paragraphs in the current embodiment, story cues would not actually occur at the beginning of the candidate story. To remedy this, a modifier truncates the story to begin with the sentence that includes the structural story cue. The end results are stories that take the form laid out in the structural story template, beginning with phrases such as “I had a dream last night,” or “I got into a fight with . . . ”

Content or Impact Filters (314)

Content or Impact filters are used to find interesting and appropriate stories, i.e., those with elevated emotion, and familiar and relevant content that, if desired, is free of profanity and other unwanted language use.

Filtering Retrieval by Affect

Filtering the retrieved relevant blog entries by affect provides the ability to select and present the strongest, most emotional stories. Beyond purely showing the most affective stories, in some configurations, under the direction of certain ARCs, the system attempts to juxtapose happy stories on a topic with angry or fearful stories on a topic.

Sentiment analysis is a modern text classification area in which systems are trained to judge the sentiment (defined in a variety of ways) of a document. The exemplary embodiment defines sentiment as valence, i.e., how positive or negative a selection of text is. In the system, a combination of case-based reasoning, machine learning, and information retrieval approaches are used. A case base of movie and product reviews is collected, each review labeled with a sentiment rating of between one and five stars (one being negative and five being positive). Omitted are reviews with a score of three as those are seen as neutral. A Naïve Bayes statistical representation is built of these reviews, separating them into two groups, positive (four or five stars) and negative (one or two stars). This corpus can be replaced by any corpus of sentiment labeled documents and the Naïve Bayes representation can be substituted with any statistical representation.

Given a target document, the system creates an “affect query” as a representation of the document. The query is created by selecting the words in the target document that exhibit the greatest statistical variance between positive and negative documents in the Naïve Bayes model, or any other statistical model. The system uses this query to retrieve “affectively similar” documents from the case base, in the exemplary system, a corpus of sentiment labeled movie and product reviews. The labels from the retrieved documents are then combined to derive an affect score between −2 and 2 for the target document (the actual scale is of course arbitrary). While others have built Naïve Bayes sentiment classifiers, this tool is more effective as the case based component preserves the differences in affective connotations of words across domains. These methods can also be used to perform sentiment analysis on a variety of different document types and in a variety of applications other than finding and presenting compelling stories as described herein.

Colloquial Filtering

For an audience to stay engaged, they must understand the content of the stories that they are hearing. That is, the story can't involve topics that the audience is unfamiliar with or contain jargon particular to some field. The story must be colloquial. The story must also not be too familiar as the audience could get bored or lose interest.

To determine how familiar a story is, the system employs a classifier that makes use of page frequencies on the web. For each word in the story, the system looks at the number of pages in which this word appears on the web, a frequency that is obtained through a simple web search. The frequency with which each word appears on the web is used as a score for how familiar the word is. Applying Zipf's Law, the system can determine how to interpret these scores. A story is then classified to be as colloquial as the language used in it. Given a set of possible stories, colloquial thresholds (high and low) are generated dynamically based on the distribution of scores of the words in the candidate stories. If more than n percent of the words in a story fall below the minimum threshold (where n is a configurable parameter), then the story is deemed to be too obscure and is discarded.

Language Filter

Another important filter is the language filter, as it judges how appropriate a story is for presentation. This filter can be configured to remove stories which include profanity, or even stories which include words that expose the fact that it was extracted from a blog and so may be confusing in the context of presentation by a system such as this. For example, some blog posts are often started with the phrase “In my last post . . . ” While this is appropriate when a reader understands that what they are reading is a blog, etc., this is inappropriate or awkward when taken out of the context of the blog posting, and presented through an embodied avatar.

To filter out stories with such language, the language filter uses a dictionary-based approach. It can be provided with a list of words for the filter. From there, the system can be configured to only filter based on those words, or to also include stems of those terms for broader coverage of morphological variants. As with all other filters, this filter may be turned “on” or “off” when appropriate.

Presentation Filters (315)

Presentation filters are used to focus on content that will sound appropriate when spoken through a computer generated voice, and presented by an animated avatar of the appropriate gender.

Presentation Syntax Filter

While syntax filtering is included in the story filters 313, it is also important in the presentation filters 315, due to the limitations of computer generated speech. Because of the nature of blogs as well as other types of online texts, they are often casually punctuated and structured. While this isn't generally a problem for the reader, it poses a problem when presented through a text-to-speech engine. Text-to-speech engines use punctuation as cues for prosody and cadence. For this reason, when a story is poorly punctuated, or it contains too many numbers, numbers with many digits, URLs, links, or email addresses, all of which sound bad when presented by a text-to-speech engine, they are filtered by the presentation syntax filter.

Optionally, the presentation syntax filter also removes stories that contain a direct quote which makes up more than one third of the story. Lengthy direct quotes are awkward when read by a computer generated voice. When a person reads a direct quote, they often change the inflection of their speech in order to indicate a different speaker. This change does not occur in computer generated voices, often resulting in listener confusion. For this reason, candidate stories that fall into this category can be discarded if desired.

Detecting Gender-Specific Stories

Another problem that can be encountered occurs when gender-specific stories are read by virtual actors of the incorrect gender. For example, if a blog author describes their experiences during pregnancy, it may be awkward to have this story performed by a male actor. Conversely, if a blogger talks about their day at work as a steward, having this read by a female could also be slightly distracting.

To avoid this problem, gender-specific stories are detected and classified. Unlike previous gender classification systems, it is not necessary for the system to attempt to classify all stories as either male or female. Rather, the system detects stories where the author's gender is evident, thus classifying stories as male, female, neutral (in the case where gender-specificity is not evident in the passage), or ambiguous (in the case where both male and female indicators are present).

To do this, the system looks for specific indicators that the story is written by a male or a female. These indicators include self-referential roles (roles in a family and job titles), physical states, and relationships. These three types of indicators are treated as three separate rules for gender detection in the system.

To detect self-referential roles in a blog, the system looks for ‘I’ references including “I am”, “I was”, “I'm”, “being”, and “as a.” These phrases indicate gender-specificity if they are followed within a certain number of words not including pronouns (the number being a configurable parameter of the system) by a female-only or male-only role such as wife, mother, groom, aunt, waitress, mailman, sister, etc. These roles have been collected from various sources and enumerated as such. This rule set is meant to detect cases such as “I am a waitress,” which would indicate that the speaker is a female. Excluding extra pronouns between the self reference and the role is intended to eliminate false positives such as “I was close to his girlfriend,” where the additional ‘his’ ensures that this rule is not applied. More complex parsing schemes may also be applied to this end if desired.

To detect physical states that carry gender connotations, the system again looks for ‘I’ references, as above, followed within a certain number of words (again a configurable parameter) by a gender-specific physical state such as “pregnant.” This rule is meant to detect cases such as “I am pregnant.” As in detecting roles, cases with extraneous pronouns between the ‘I’ reference and the physical state are also ignored. This eliminates false positives such as “I was amazed by her pregnancy.” Again, more complex parsing schemes may be used if desired.

To detect male or female-only relationships, the system looks for use of the word ‘my’ followed within five words by a male or female only relationship such as husband, ex-girlfriend, etc. This rule is intended to catch cases such as “my ex-husband.” Again, cases with extraneous pronouns are ignored to eliminate false positives such as “my feelings towards his girlfriend.” Although the above examples assume heterosexual relationships, other types of relationships can be considered.

If any of three above indicators exists in a story, and they agree on a male/female classification, then the story is classified as such. If they disagree, it is classified as ‘ambiguous.’ If no indicators exist, it is classified as ‘neutral.’ This method of gender classification can be used on a variety of document types and in a variety of applications other than finding and presenting compelling stories as described herein.

Presentation Modifiers (317)

In addition to presentation filters 315, a set of presentation modifiers 317 is aimed at altering the text to make it more appropriate for presentation through a computer generated voice. Upon reaching the presentation modifiers 31 7, the candidate stories have passed through the three major filter sets (story filters 313, content or impact filters 314, and presentation filters 315) as well as the story modifiers 316. The next step is to prepare them to be spoken by a voice generation engine.

If the story contains any parenthetical, bracketed or braced content, this content is removed. This includes any remaining HTML or XML tags. This is based on the notion that if you were reading this post to a friend, you might ignore such content as it breaks up the flow of the story. Adjacent punctuation is condensed as the speech engines typically use this punctuation to indicate pauses, and so this punctuation would result in long pauses. Any remaining numbers, dates, and monetary amounts are altered to be readable by the speech engines. Finally, abbreviations are replaced by their expanded form, and any remaining acronyms or abbreviates are expanded to instruct the speech engine correctly. For example, “APA” would be expanded to “A.P.A.” so that the speech engine spells out the acronym as opposed to treating it as a word.

Upon completing these modifications, the candidate stories 209 may be passed through filters a second time. This ensures that any transformations made on the text did not change its value or quality as a story, or how appropriate it is for presentation. These methods can also be applied to other document types and in other applications to improve the quality of text either with regard to readability or to quality in spoken presentation.

Additional Modifiers

Note that the exemplary system illustrated in FIG. 3 does not include content/impact modifiers. However, such modifiers can be implemented without departing from the spirit and scope of the invention. Such modifiers, or amplifiers, would alter the candidate stories so that they are more impactful, emotional or colloquial. This system would transform words that occurred in a story to more emotional words with the same connotation. The end result would be a story that conveyed the same meaning, yet with more emotional impact than in its original form.

This could be implemented with a combination of a part of speech tagger, a connected thesaurus and a Naïve Bayes sentiment classification model. The system would attempt to replace certain adjectives in the candidate story, namely those that have only one sense in the connected thesaurus, thus indicating that they are unambiguous. From the synonym set, it could choose a synonym with a higher “sentiment magnitude” as indicated by the Naïve Bayes sentiment classification model. This “sentiment magnitude” is a calculation of how emotion-bearing a term is. This system will scale and be configurable as to how much to amplify a story.

Presentation Engine

While finding compelling stories is an important aspect of the system, conveying them to an audience in an engaging way is just as crucial. In the simplest case, individual stories may simply be conveyed individually to a user. In more complicated cases, however, the performance must follow a dramatic arc that keeps the audience engaged. Text-to-speech technology and graphics must be believable (or suitable) and evocative.

The Display

As illustrated in FIG. 1A, an example of the system embodied in a physical display includes five flat panel monitors in the shape of an ‘x’. The four outer monitors display actors. The actors' faces are synchronized with voice generation technology controlled, for example through the Microsoft Speech API, to match mouth positions on the faces to viseme events, with lip position cues output by the MS or other applicable API. Within this configuration, the actors are able to read stories and turn to face the actor currently speaking.

The central screen in this embodiment (FIG. 1B) displays emotionally evocative words, pulled from the text currently being spoken, falling in constant motion. These words are extracted from the stories using the emotion classification technology described above on “Filtering Retrieval by Affect”. The most emotional words are extracted by finding the words with the largest disparity between positive and negative probabilities in a Naïve Bayes statistical model of valence labeled reviews.

Other embodiments of the display include a destination entertainment web site, rather than a physical installation, as described above.

Adaptive Retrieval Charts (ARCs) (319)

Given the above classifiers and filters, the system is able to retrieve a set of compelling stories. These filters and classifiers also give us a level of control of the performance similar to that of a director. Having information about each story such as its “emotional point of view,” its “familiarity,” and the likely gender of its author, the structure of an ongoing performance or individual story presentation in an online system can be planned out from a high level view before retrieving the performance content, giving the performance a flow, based not only on content, but on emotion, familiarity, on-point vs. tangential, etc. Given a topic, when the system is presenting multiple stories, the system can juxtapose stories with different emotional stances, different levels of familiarity, and on-point vs. off-point. These affordances give a meaningful structure to the performance.

To provide a high level control of the performance of multiple stories if desired, the system has an architecture for driving the retrieval of performance content. The structures, called Adaptive Retrieval Charts (or ARCs), provide high level instructions to the presentation engine as to what is needed, where to find it, how to find it, how to evaluate it, how to modify queries if needed, and how to adapt the results to fit the current goal set.

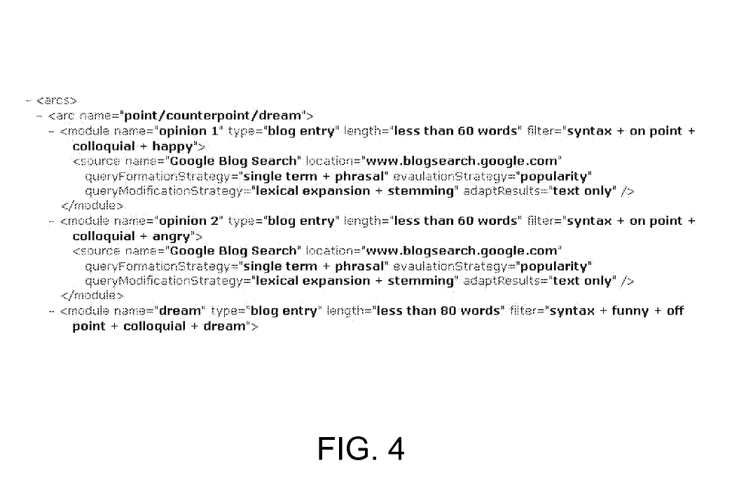

FIG. 4 illustrates a sample dramatic ARC used to drive a performance. The pictured ARC defines a point/counterpoint/dream interaction between agents. The three modules define three different information needs, as well as the sources for retrieval to fulfill these needs. The first module specifies for a blog entry that is on point to a specified topic, has passed through the syntax and colloquial filters, and is generally happy on the topic. The module specifies using Google™ Blog Search as a source. The source node specifies to form queries by single words as well as phrases related to the topic. If too few results are returned from this source, we have specified that queries are to be continually modified by lexical expansion and stemming.

The ARC extensible framework allows for interactions from directors with little knowledge of the underlying system.

Emphasis and Emotion Mark Up (318)

While text-to-speech systems have made great strides in improving believability of generated speech, these systems are not perfect. Their focus has been on telephony systems, where the length of time of spoken speech is limited and emotional speech is unnecessary. In watching a performance using such text-to-speech systems, the voices tend to drone monotonously during stories longer than one to two sentences. An additional problem is caused by the stream of consciousness nature of some blogs, resulting in casual formatting with poor or limited punctuation. As mentioned earlier, text-to-speech systems generally rely on punctuation to provide natural pauses in the speech. In blogs where limited punctuation was present, the voices tended to drone on even more.

In response to these issues, the system also includes a model for emotional speech emphasis. First, the system uses a sentence level emotion classifier to determine which sentences are highly affective, and which emotion they are characterized by. In the exemplary system, the text is marked up at the sentence level for its emotional content (happy, sad, angry, neutral, etc.). This can be done in larger spans such as at the paragraph or story level, or in smaller spans such as the word or phrase level. The models of emotion used can be replaced by a more or less detailed model of emotion.

Many speech engines allow XML or other markup to control the volume, rate and pitch of the voices, as well as to insert pauses of different periods (specified in milliseconds) in the speech. The system uses this XML or other markup, in combination with an off-the-shelf audio processing toolkit, to alter the sound of the speech according to its emotional markup. For example, to handle a happy sentence, the pitch will be raised, rate will be increased, and the pitch of the voice will rise slightly at the end of the sentence.

In addition to using a model of emotional emphasis, the system inserts pauses into the audio stream at natural breaking points. This technique tends to improve performance on blogs with limited punctuation.

The emphasis and emotion markup described above is also used to control the gestures, motion, and facial expressions of the animated avatars presenting the stories. Particular gestures or expressions can be associated with particular emotional states as expressed in the markup language, and used to portray the appropriate gesture or expression as the story is presented. Finally, the markup methods proposed above can be used on a variety of documents and in a variety of applications other than finding and presenting compelling stories.

The steps of the retrieval engine 201, filtering and modification engine 202, and presentation engines are not limited to a particular order. For example, the filtering and modification engine 202 can perform the filtering and modification steps in any order and can repeat any of the steps multiple times. Ordering can be chosen as desired to improve efficiency or other characteristics of the system. Further, the concepts in many of the steps can be relevant across multiple engines in the system. For example, structural cues to identify compelling stories may be used by both the retrieval engine 201 and the filtering and modification engine 202 as described above.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks, and that networks may be wired, wireless, or a combination of wired and wireless. Other variations and embodiments are possible in light of above teachings, and it is thus intended that the scope of invention not be limited by this Detailed Description, but rather by Claims following.

We claim:

1. A method for providing compelling stories from online sources, comprising:
(a) retrieving documents likely to contain stories from the online sources;
(b) extracting candidate stories from the documents; and
(c) filtering the candidate stories to identify stories with predefined levels of sentiment;
(d) preparing the filtered stories for spoken presentation by animated characters; and
(e) presenting the prepared stories using computer generated speech by the animated characters.

2. The method of claim 1, wherein the retrieving (a) comprises:
(a1) forming queries to retrieve the documents containing structural cues indicative of a type of story; and
(a2) running the queries using search engines.

3. The method of claim 2, wherein the structural cues comprise text or phrases indicating a writer is starting to tell a story.

4. The method of claim 2, wherein the structural cues comprise text or phrases indicating a situational category for the type of story.

5. The method of claim 2, wherein the queries further retrieve the documents matching predefined topics of interest.

6. The method of claim 1, wherein the extracting (b) comprises:
(b1) finding occurrences of query terms and structural cues in the documents; and
(b2) for each occurrence, searching for a first natural breaking point and a second natural breaking point following the first natural breaking point, wherein a section of text between the first and second natural breaking points comprise the candidate story.

7. The method of claim 6, wherein the section of text comprises a complete paragraph.

8. The method of claim 1, wherein the filtering (c) comprises:
(c1) evaluating relevance of the candidate stories to structural cues used in the retrieval of the documents.

9. The method of claim 8, wherein for each candidate story, the evaluating (c1) comprises:
(c1i) determining if the structural cues are present in the candidate story;
(c1ii) determining if the structural cues appear in a first sentence of the candidate story; and
(c1iii) eliminating the candidate story if the structural cues are not present in the candidate story or if the structural cues do not appear in the first sentence.

10. The method of claim 9, wherein for each candidate story, the evaluating (c1) further comprises:
(c1iv) phrasally analyzing the candidate story according to a topic of interest used in the retrieval of the documents; and
(c1v) eliminating the candidate story if the candidate story is not sufficiently on point with the topic of interest.

11. The method of claim 1, wherein the filtering (c) comprises:
(c1) filtering the candidate stories by syntax to eliminate candidate stories comprising syntactical indicators that the candidate story is not a narrative.

12. The method of claim 1, wherein the filtering (c) comprises:
(c1) performing sentiment analysis on the candidate stories to classify the candidate stories based on affective valence; and
(c2) eliminating the candidate stories that are not within a predetermined range of affective valence.

13. The method of claim 12, wherein the performing (c1) comprises:
(c1i) labeling documents within a corpus with a sentiment rating;
(c1ii) removing the documents within the corpus labeled with a neutral sentiment rating;
(c1iii) building a statistical representation of the remaining documents in the corpus, wherein the remaining documents in the corpus are separated into a positive group and a negative group;
(c1iv) creating an affect query as a representation of a target candidate story, wherein the affect query is created by selecting words in the target candidate story that exhibit the greatest statistical variance between the positive and the negative documents in the statistical representation;
(c1v) using the affect query to retrieve affectively similar documents from the corpus; and
(c1vi) combining the labels from the retrieved documents to derive an affect score for the target document.

14. The method of claim 13, wherein the eliminating (c2) comprises:
(c2i) if the affect score is not within a predetermined range of values, then eliminating the target candidate story.

15. The method of claim 1, wherein the filtering (c) comprises:
(c1) determining a number of web pages on which each word in the candidate stories appears;
(c2) determining a score for how familiar each word is based on the number;
(c3) determining colloquial thresholds based on a distribution of the scores for the words in the candidate stories;
(c4) for each candidate story, determining if the candidate story meets the colloquial thresholds; and
(c5) eliminating the candidate story, if the candidate story does not meet the colloquial thresholds.

16. The method of claim 1, wherein the filtering (c) comprises:
(c1) for each candidate story, determining if the candidate story comprises undesirable language; and
(c2) eliminating the candidate story, if the candidate story comprises undesirable language.

17. The method of claim 1, wherein the filtering (c) comprises:
(c1) eliminating candidate stories that comprise problematic syntax for text-to-speech engines.

18. The method of claim 17, wherein the problematic syntax comprises poor punctuation, too many numbers, numbers with many digits, URLs, links, email addresses, or direct quotes.

19. The method of claim 1, wherein for each candidate story, the filtering (c) comprises:
(c1) identifying indicators of a gender of an author of the candidate story, wherein the indicators comprise self-referential roles, physical states, and relationships;
(c2) determining if the indicators agree on the gender of the author; and
(c3) if the indicators agree on the gender of the author, then classifying the candidate story with the gender.

20. The method of claim 1, wherein the filtering (c) comprises:
(c1) modifying the candidate stories to improve readability by a text-to-speech engine.

21. The method of claim 20, wherein the modifications can comprise:
removal of any parenthetical, bracketed or braced content,
condensation of adjacent punctuation,
alteration any numbers, dates, or monetary amounts to be readable by the text-to-speech engine, and
expansion of acronyms or abbreviations.

22. The method of claim 1, wherein the preparing (d) comprises:
(d1) structuring the presentation using dramatic Adaptive Retrieval Charts (ARCs), wherein the ARCs comprise instructions for the retrieving (a), extracting (b), and filtering (c) based on a goal set.

23. The method of claim 1, wherein for each filtered candidate story, the preparing (d) comprises:
(d1) determining which sentences of the filtered candidate story are highly affective and which emotion the sentences are characterized by; and
(d2) marking up the highly affective sentences, such that the marked up sentences have more emphasis in a presentation of the computer generated speech and the animated characters.

24. The method of claim 23, wherein the marking up comprises marking up of a volume, rate, or pitch, or inserting pauses.

25. A method for providing compelling stores from online sources, comprising:
(a) forming queries to retrieve documents from the online sources containing query terms and structural cues indicative of a type of story;
(b) running the queries using search engines;
(c) finding occurrences of the query terms and structural cues in the retrieved documents; and
(d) for each occurrence, searching for a first natural breaking point and a second natural breaking point following the first natural breaking point, wherein a section of text between the first and second natural breaking points comprise a candidate story.

26. The method of claim 25, wherein the structural cues comprise text or phrases indicating a writer is starting to tell a story.

27. The method of claim 25, wherein the structural cues comprise text or phrases indicating a situational category for the type of story.

28. The method of claim 25, wherein the queries further retrieve the documents matching predefined topics of interest.

29. The method of claim 25, wherein the section of text comprises a complete paragraph.

30. A method for providing compelling stories from online sources:
(a) obtaining candidate stories extracted from documents retrieved from the online sources, wherein the documents are retrieved using a query comprising query terms and structural cues indicative of a type of story;
(b) for each candidate story, determining if the structural cues are present;
(c) for each candidate story, determining if the structural cues appear in a first sentence; and
(d) eliminating the candidate stories in which the structural cues are not present or where the structural cues do not appear in the first sentence.

31. The method of claim 30, wherein the queries further retrieve the documents matching predefined topics of interest, wherein the method further comprises:
(e) for each candidate story, phrasally analyzing the candidate story according to the topics of interest; and
(f) eliminating the candidate stories that are not sufficiently on point with the topics of interest.

32. A method for providing compelling stories from online sources, comprising:
(a) obtaining candidate stories extracted from the online sources;
(b) labeling documents within a corpus with sentiment ratings;
(c) removing the documents within the corpus labeled with a neutral sentiment rating;
(d) building a statistical representation of the remaining documents in the corpus, wherein the remaining documents in the corpus are separated into a positive group and a negative group;
(e) creating an affect query as a representation of a target candidate story, wherein the affect query is created by selecting words in the target candidate story that exhibit the greatest statistical variance between the positive and the negative documents in the statistical representation;
(f) using the affect query to retrieve affectively similar documents from the corpus;
(g) combining the labels from the retrieved documents to derive an affect score for the target candidate story; and
(h) if the affect score is not within a predetermined range of values, then eliminating the target candidate story from the candidate stories.

33. A method for providing compelling stories from online sources, comprising:
(a) obtaining a candidate story extracted from the online sources;
(b) identifying indicators of a gender of an author of the candidate story, wherein the indicators comprise self-referential roles, physical states, and relationships;
(c) determining if the indicators agree on the gender of the author;
(d) if the indicators agree on the gender of the author, then classifying the candidate story with the gender;
(e) presenting the candidate story using computer generated speech by an animated character with the gender.

34. A method for providing compelling stories from online sources, comprising:
(a) obtaining candidates stories extracted from the online sources;
(b) modifying the candidate stories to improve readability by a text-to-speech engine, wherein the modifications comprise:
removal of any parenthetical, bracketed or braced content,
condensation of adjacent punctuation,
alternation of any numbers, date, or monetary amounts to be readable by the text-to-speech engine, and
expansion of acronyms or abbreviations; and
(c) presenting the modified candidate stories using computer generated speech by animated characters.

35. A method for providing compelling stories from online sources, comprising:
(a) obtaining candidate stories extracted from the online sources;
(b) determining which sentences of the candidate stories are highly affective and which emotion the sentences are characterized by;
(c) marking up the highly affective sentences, such that the marked sentences have more emphasis in a presentation of computer generated speech by animated characters; and
(d) presenting the marked up stories using the computer generated speech by the animated characters.

36. The method of claim 35, wherein the marking up comprises marking up of a volume, rate, or pitch, or inserting pauses.

37. A system for providing compelling stories from online sources, comprising:
a retrieval engine for retrieving documents likely to contain stories from the online sources and for extracting candidate stories from the documents;
a filtering and modification engine for filtering the candidate stories to identify stories with predefined levels of sentiment and for preparing the filtered stories for spoken presentation by animated characters; and
a presentation engine for presenting the prepared stories using computer generated speech by animated characters.

38. The system of claim 37, wherein the retrieval engine forms queries to retrieve the documents containing structural cues indicative of a type of story and runs the queries using search engines.

39. The system of claim 37, wherein the retrieval engine finds occurrences of query terms and structural cues in the documents, and for each occurrence, searches for a first natural breaking point and a second natural break point following the first natural breaking point, wherein a section of text between the first and second natural breaking points comprise the candidate story.

40. The system of claim 37, wherein the filtering and modification engine comprises story filters for evaluating relevance of the candidate stories to structural cues used in the retrieval of the documents.

41. The system of claim 37, wherein the filtering and modification engine comprises story filters for filtering the candidate stories by syntax to eliminate candidate stories comprising syntactical indicators that the candidate story is not a narrative.

42. The system of claim 37, wherein the filtering and modification engine comprises content or impact filters for performs sentiment analysis on the candidate stories to classify the candidate stories based on affective valence, and eliminating the candidate stories that are not within a predetermined range of affective valence.

43. The system of claim 37, wherein the filtering and modification engine comprises colloquial filtering for determining a number of web pages on which each word in the candidate stories appears, determining a score for how familiar each word is based on the number, determining colloquial thresholds based on a distribution of the scores for the words in the candidate stories, for each candidate story determining if the candidate story meets the colloquial thresholds, and eliminating the candidate story if the candidate story does not meet the colloquial thresholds.

44. The system of claim 37, wherein the filtering and modification engine comprises a language filter for determining if the candidate story comprise undesirable language, and eliminating the candidate story if the candidate story comprises undesirable language.

45. The system of claim 37, wherein the filtering and modification engine comprises presentation filters for eliminating candidate stories that comprise problematic syntax for text-to-speech engines.

46. The system of claim 37, wherein for each candidate story, the filtering and modification engine identifies indicators of a gender of an author of the candidate story, wherein the indicators comprise self-referential roles, physical states, and relationships, determines if the indicators agree on the gender of the author, and if the indicators agree on the gender of the author, then classifying the candidate story with the gender.

47. The system of claim 37, wherein the filtering and modification engine comprises presentation modifiers for modifying the candidate stories to improve readability by a text-to-speech engine.

48. The system of claim 37, wherein the presentation engine structures the presentation using dramatic Adaptive Retrieval Charts (ARCs), wherein the ARCs comprise instructions for retrieving, extracting, and filtering based on a goal set.

49. The system of claim 37, wherein for each filtered candidate story, the presentation engine determines which sentences of the filtered candidate stories are highly affective and which emotion the sentences are characterized by, and marking up the highly affective sentences such that the marked up sentences have more emphasis in a presentation of the computer generated speech and the animated characters.

50. A computer readable medium with program instructions for providing compelling stories from online sources, comprising instructions for:
(a) retrieving documents likely to contain stories from the online sources;
(b) extracting candidate stories from the documents; and
(c) filtering the candidate stories to identify stories with predefined levels of sentiment;
(d) preparing the filtered stories for spoken presentation by animated characters; and
(e) presenting the prepared stories using computer generated speech by the animated characters.
